(19) United States
(12) Patent Application Publication
(10) Pub. No.: US 2008/0244941 A1
(43) Pub. Date: Oct. 9, 2008

(54) Water home-delivery bottle and water supply unit

(75) Inventor: Takeshi Yukawa, Osaka (JP)

Correspondence Address: BIRCH STEWART KOLASCH & BIRCH, PO BOX 747, FALLS CHURCH, VA, 22040-0747, US

(73) Assignee: O S G Corporation Co., Ktd., Osaka-Shi (JP)

(21) Appl. No.: 11/730,726

(22) Filed: Apr. 3, 2007

(51) Int. Cl. G09F 23/00

(52) U.S. Cl. 40/310; 40/299.01

(57) ABSTRACT

Conventionally, plastic bottles accommodating drink water with advertisement other than its product name have existed and demand for such bottles has been increased recently. However, there is no water home-delivery bottle having advertisement. Therefore, This invention intends to enable advertisement in a water home-delivery field.

More specifically, the invention provides a water home-delivery bottle having advertisement. Further, the advertisement is attached on an outer periphery of the bottle using a detachable fixture.

### BACKGROUND OF THE INVENTION

1. Field of the Invention

The present invention relates to a water home-delivery bottle, and more particularly to a water home-delivery bottle having advertisement and a water supply unit.

2. Description of the Related Art

With a water supply unit preliminarily disposed at home or in office, bottles accommodating drink water have been delivered.

Conventionally, there have existed plastic bottles accommodating drink water with advertisement other than its product name (Japanese Patent Application No. 2001-130580).

Conventionally, the plastic bottles accommodating drink water with advertisement other than the product name have existed, and recently, demand for such bottles has been increased. However, there is no water home-delivery bottle having advertisement.

### SUMMARY OF THE INVENTION

Accordingly, in views of the above circumstances, the present invention intends to provide a water home-delivery bottle with advertisement in order to enable advertisement in a water home-delivery field.

Specifically, the present invention provides the water home-delivery bottle wherein advertisement is provided on an outer periphery of the bottle by fitting a detachable fixture.

Further, the present invention provides the water home-delivery bottle wherein the advertisement is provided directly on the outer periphery thereof.

Still further, the present invention provides the water home-delivery bottle where in the advertisement is provided using a detachable rod.

The present invention also provides a water supply unit having advertisement, enabling advertisement also in a water supply unit field.

Specifically, the present invention provides the water supply unit wherein advertisement is provided on an outer periphery of the water supply unit by fitting a detachable fixture.

Further, the present invention provides the water supply unit wherein the advertisement is provided directly on the outer periphery thereof.

Still further, the present invention provides the water supply unit wherein the advertisement is provided using a detachable rod.

### BRIEF DESCRIPTION OF THE DRAWINGS

FIG. 1 is a front view showing a condition in which a bottle is connected to a water supply unit in an inverted state with advertisement attached to the bottle according to an embodiment of the present invention;

FIG. 2 is a front view of the bottle of the present invention with an advertisement medium attached thereto;

FIG. 3 is a perspective view of the advertisement medium of the present invention;

FIG. 4 is a front view of the bottle with the advertisement of the present invention attached directly to the outer peripheral face thereof;

FIG. 5 is a front view of the bottle achieving the advertisement with a rod of the present invention;

FIG. 6 is a front view of a condition in which the bottle is connected to the water supply unit in the inverted state with the advertisement medium attached to the water supply unit, according to the embodiment of the present invention;

FIG. 7 is a perspective view of the advertisement medium of the present invention; and

FIG. 8 is a front view of a condition in which the advertisement is achieved on the water supply unit using the rod of the present invention while another advertisement is attached directly to the outer peripheral face of the water supply unit.

### DESCRIPTION OF THE PREFERRED EMBODIMENTS

The present invention will be described in detail based on specific embodiments shown in the accompanying drawings.

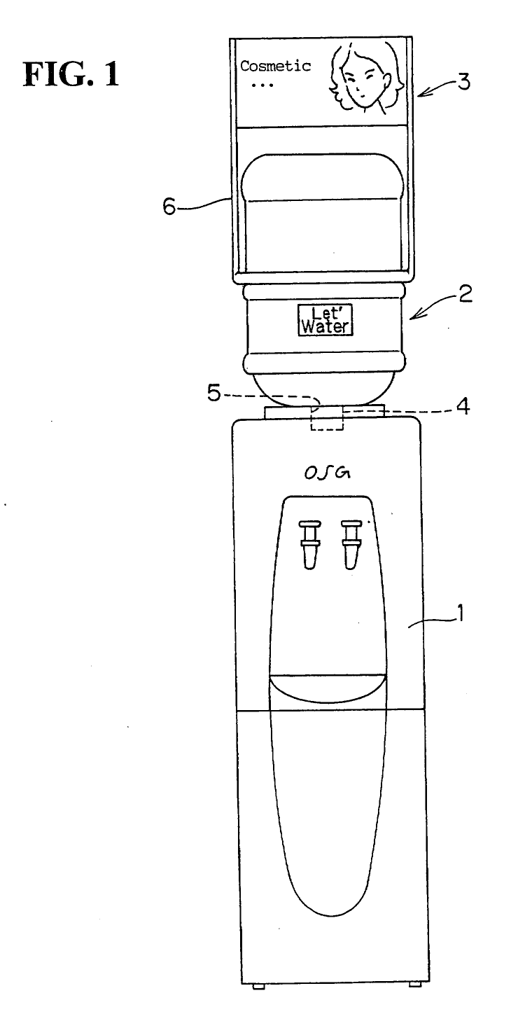

In FIG. 1, reference numeral 1 denotes a water supply unit for supplying drink water in a hot or cold state, reference numeral 2 denotes a bottle delivered with the drink water accommodated therein, and reference numeral 3 denotes an advertisement medium.

The water supply unit 1 is provided with a corporate name (for example, OSG) of a company which supplies the drink water to exert a function of advertisement.

The delivered bottle 2 accommodates the drink water and a narrow port 4 is provided on the top thereof. The port 4 is directed downward by inverting the bottle 2 carried to the water supply unit 1 and fitted to a receiver port 5 provided in the top of the water supply unit 1. Advertisement “Let′ Water” is attached to the outer peripheral face of the bottle 2. As the bottle 2, usually, a resin bottle is used.

The advertisement medium 3 is attached to the outer periphery of the bottle 2 using a fixture 6. In this example, this advertisement contains a lady's face and a caption “Cosmetic item is . . . ”.

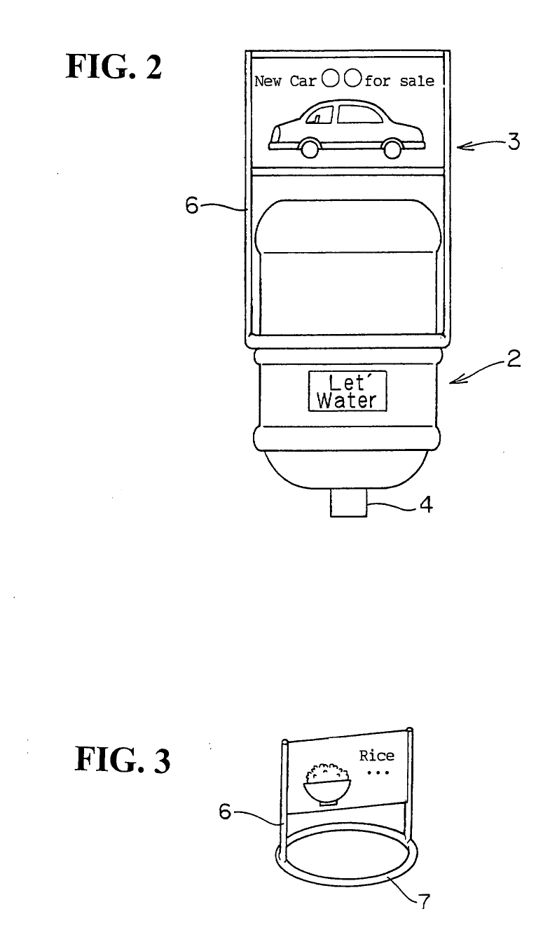

FIG. 2 shows another example of advertisement, which indicates an automobile figure and a caption “New Car XX released!”.

FIG. 3 shows still another example of advertisement, which indicates a representation of rice ball with rice and a caption “Rice is . . . ”.

Although the fixture 6 is made of metal, resin or other material, metal is preferable and a bottom portion of the fixture 6 is formed into a circular ring 7.

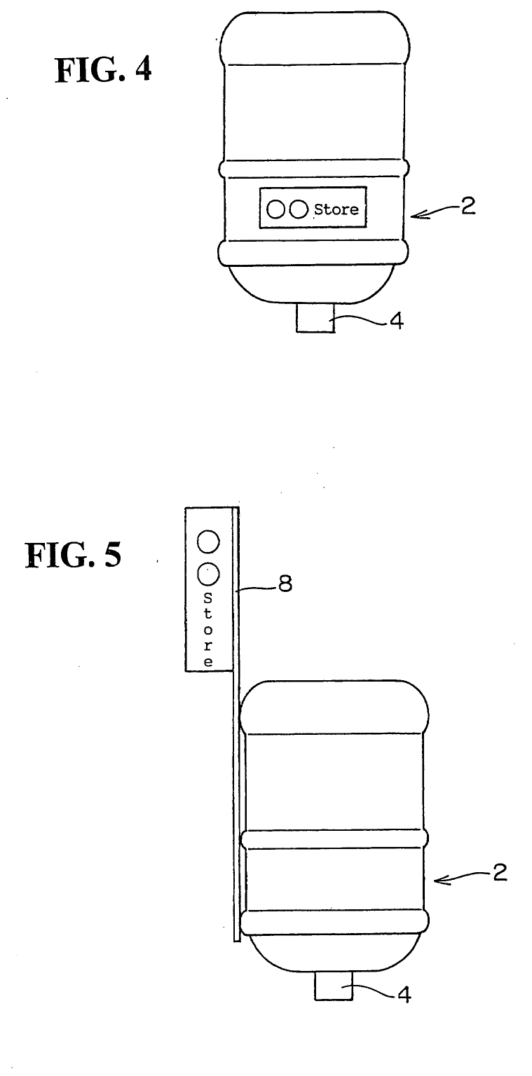

FIG. 4 shows still anther example of advertisement, and advertisement saying “XX Company” is attached to the outer peripheral face of the bottle 2.

FIG. 5 shows yet still another example of advertisement, and a rod 8 is attached to the bottle 2 with advertisement saying “XX Company” being attached to the top of the rod 8.

According to the present invention, advertising effect is always exerted by attaching advertisement to the water home-delivery bottle.

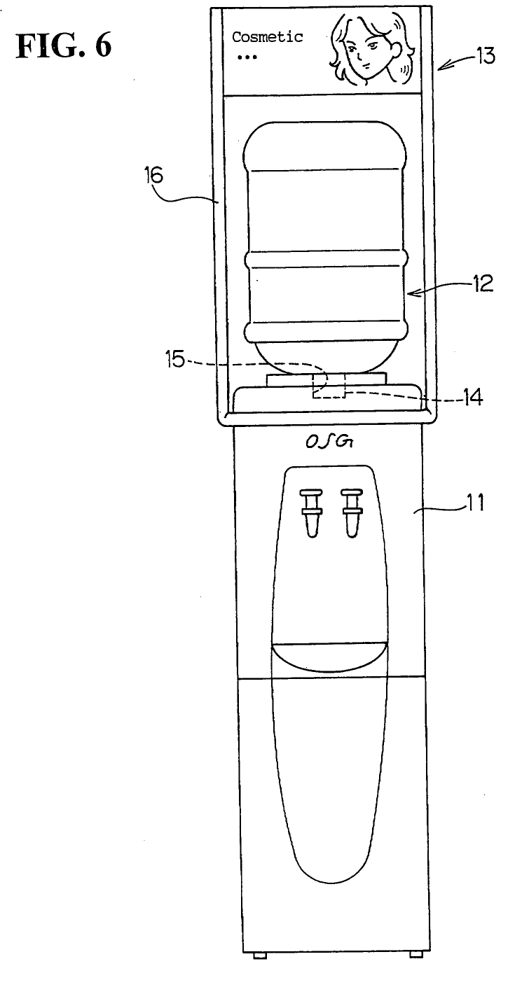

In FIG. 6, reference numeral 11 denotes a water supply unit for supplying the drink water in a hot or cold state, reference numeral 12 denotes a bottle delivered with the drink water accommodated therein, and reference numeral 13 denotes an advertisement medium.

The water supply unit 11 is provided with a corporate name (for example, OSG) of the company which supplies the drink water to exert the function of advertisement.

A delivered bottle 12 accommodates the drink water, and a narrow port 14 is provided on the top thereof. The port 14 is directed downward by inverting the bottle 12 carried to the water supply unit 11 and fitted to a receiver port 15 provided in the top of the water supply unit 11. As the bottle 12, usually, a resin bottle is used.

The advertisement medium 13 is attached to the outer periphery of the water supply unit 11 using a fixture 16. In this example, the advertisement contains a lady's face and a caption “Cosmetic item is . . . ”.

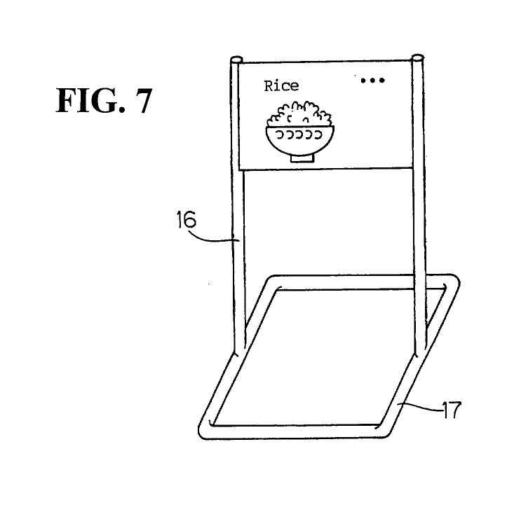

FIG. 7 shows another example of advertisement, which indicates a representation of rice ball with rice and a caption “Rice is . . . ”. Although the fixture 16 is made of metal, resin or other material, metal is preferable, and a bottom portion of the fixture 16 is formed into a square ring 17.

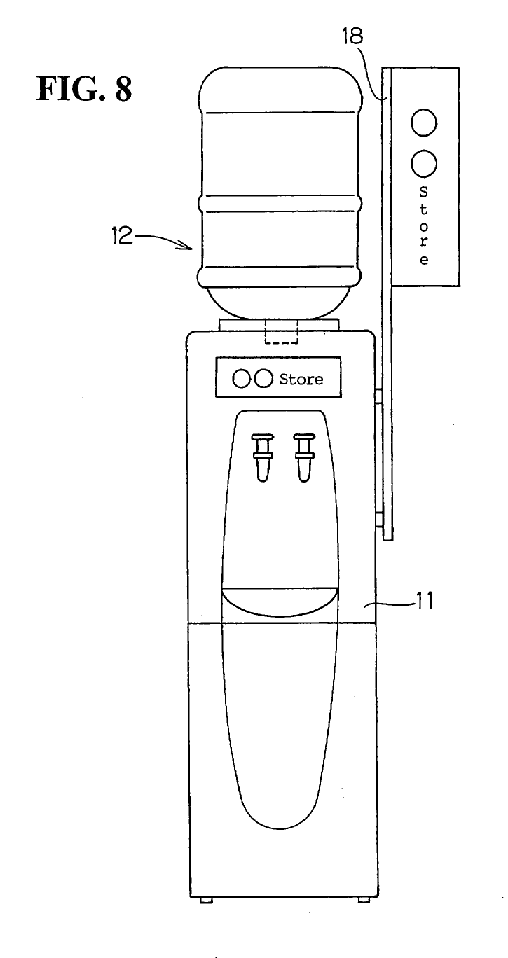

FIG. 8 shows a still further example of advertisement in which a rod 18 is attached to the water supply unit 11 and advertisement saying “XX Company” is attached to the top of the rod 18 while advertisement saying “XX Company” is attached to the outer peripheral face of the water supply unit 11.

According to the present invention, advertising effect is always exerted by attaching the advertisement to the water supply unit.

Although the present invention concerns the water home-delivery bottle having advertisement, the invention can be applied to an alcoholic drink bottle delivered.

The present invention enables advertisement in a water home-delivery field because it provides the water home-delivery bottle having the advertisement.

More specifically, the present invention provides the water home-delivery bottle having advertisement using the fixture fitted detachably to the outer periphery of the bottle.

Further, the present invention provides the water home-delivery bottle having the advertisement directly attached to the outer peripheral face.

Further, the present invention provides the water home-delivery bottle having the advertisement using a detachable rod.

The present invention enables advertisement in a water supply unit field because it provides the water supply unit having the advertisement.

More specifically, the present invention provides the water supply unit having the advertisement using the fixture fitted detachably to the outer periphery of the water supply unit.

Further, the present invention provides the water supply unit having the advertisement directly attached to the outer periphery thereof.

Further, the present invention provides the water supply unit exerting advertisement using the detachable rod.

What is claimed is:

1. A water home-delivery bottle having advertisement.

2. The water home-delivery bottle according to claim 1, wherein the advertisement is attached to an outer periphery of the bottle by fitting a detachable fixture.

3. The water home-delivery bottle according to claim 1, wherein the advertisement is attached directly to the outer periphery thereof.

4. The water home-delivery bottle according to claim 1, wherein the advertisement is provided using a detachable rod.

5. A water supply unit having advertisement.

6. The water supply unit according to claim 5, wherein the advertisement is attached to an outer periphery of the water supply unit by fitting a detachable fixture.

7. The water supply unit according to claim 5, wherein the advertisement is attached directly to the outer periphery thereof.

8. The water supply unit according to claim 5, wherein the advertisement is provided using a detachable rod.
